(19) United States
(12) Patent Application Publication
(10) Pub. No.: US 2002/0178147 A1
(43) Pub. Date: Nov. 28, 2002

(54) Fleet servicing method

(76) Inventors: Pedro Arroyo, Castelldefels (ES); Silvia Fradera, Perpetua De Mogoda (ES)

Correspondence Address: JOAN M. MCGILLYCUDDY, AKZO NOBEL INC., 7 LIVINGSTONE AVENUE, DOBBS FERRY, NY, 10522-3408, US

(21) Appl. No.: 10/146,460

(22) Filed: May 15, 2002

(30) Foreign Application Priority Data
May 15, 2001 (EP) 01201802.4

(51) Int. Cl. G06F 7/00

(52) U.S. Cl. 707/2

(57) ABSTRACT

Method for servicing a fleet of vehicles, e.g., for maintenance, repairs, restyling and/or refinishing, using at least one data processing system and a number of user entries, including service center entries and at least one fleet manager's entry, at least a part of the user entries being linked to the data processing system via a data communication network, e.g., an extranet, wherein

at least one of the data processing systems comprises a status database relating to the service status of all vehicles present at the service center;

the data processing system provides the fleet manager's entry with a user interface for requesting access to the status database for reading status information;

the data processing system provides the service center's entry with a user interface for updating the status database;

on the basis of information derived from the status database the fleet manager adjusts the planning of servicing jobs.

The data processing systems are linked to a third type of user entry for one or more suppliers, e.g. paint suppliers, and include a stock database including information about the stock of one or more products present at one or more of the service centers, and optionally allowing reading information from the status database.

The present application claims priority of European Patent Application Serial No. 01201802.4, filed on May 15, 2001.

### FIELD OF THE INVENTION

The present invention relates to a method for servicing a fleet of vehicles, e.g., for maintenance, repairs, restyling and/or refinishing. In this context, a fleet is any centrally managed group of vehicles, e.g. a fleet of company cars or a group of cars to be repaired or serviced belonging to clients of an insurance company.

### BACKGROUND OF THE INVENTION

Companies active in the field of delivering goods or services generally own a fleet of vehicles, which is larger than a single service center can service. Timely servicing of all vehicles requires time- and money-consuming planning and organization. Particularly if, for example, the revision of a house style requires the refinishing of all vehicles of a company's fleet, a lot of logistical planning and organization is involved, not only by the fleet owner but also from the side of the service centers, which need to plan their jobs and stocks, and from the side of the wholesalers and manufacturers of the raw materials and products to be used for the jobs.

To improve effective cost control, assurance companies, active in assurancy of vehicle repair, tend to be more actively involved in the control of repair jobs for damages of their client's cars or vehicles. Allocation of the required repair jobs at the various available body shops, and quality, cost and progress control require intensive planning and administrative burden.

The object of the invention is a system allowing integral and direct control and fine tuning of the planning and logistics of servicing jobs for a fleet of vehicles by a fleet manager, such as for instance a fleet owner or an assurance company, as well as by the service centers, and preferably also by the supplier of the required raw materials or spare parts.

### SUMMARY OF THE INVENTION

The object of the invention is achieved by a method for servicing a fleet of vehicles using at least one data processing system and a number of service center entries and at least one fleet manager's entry, at least a part of the user entries being linked to the data processing system via a data communication network, wherein at least one of the data processing systems comprises a status database relating to the service status of all vehicles present at the service center; and wherein the data processing system provides the fleet manager's entry with a user interface for requesting access to the status database for reading status information; and wherein the data processing system provides the service center's entry with a user interface for updating the status database. On the basis of information derived from the status database the fleet manager can adjust his planning of servicing jobs. This allows direct and interactive planning and control of service jobs from two sides.

### DETAILED DESCRIPTION OF THE INVENTION

The service job in question may involve, e.g., maintenance, repairs, restyling, refinishing, etc. . . . . A particular example is the refinishing of a complete fleet of cars when a company house style is changed.

In a preferred embodiment, one or more of the data processing systems are linked to a third type of user entry for one or more suppliers, e.g., paint suppliers, and include a stock database including information about the stock of one or more products, such as paint for refinishing or spare parts, present at one or more of the service centers, and optionally allowing reading information from the status database. Three-party entry information systems allow simultaneous and integral planning by three different parties, which with the existing prior art means was not possible up till now. A paint supplier can check the number of cars to be refinished by a given service center or body shop and determine the amount of paint required, without the need to order on the part of the body shop.

The supplier can for example be a manufacturer or a wholesaler. Preferably, the manufacturer and the wholesaler have separate entries in the system. That way, planning by the manufacturer can be integrated into the system. It also allows supervision by the manufacturer of the logistics at the wholesalers'. Preferably, the manufacturer also has access to the status databases and stock databases, so a high degree of fine-tuning of stock planning and logistics can be achieved. Moreover, such a system allows streamlining and short-cutting of administrative procedures and a flow of information between the manufacturer at one end of the process and the fleet manager at the other end. For instance, it allows simplified procedures for invoicing. The manufacturer can invoice the fleet manager directly for the complete service job, for example with a fixed price per vehicle. The service centers and the wholesalers can invoice the manufacturer for their additional services.

The service centers can indicate how many vehicles can be serviced at which time. On the basis of this information, the fleet manager can plan when he will take which cars to which service centers. Preferably, this planning is fed into the status database. That way, the manufacturer can monitor the entire process and can adapt his planning to the planning of the fleet manager. For example, the manufacturer can deliver a fixed amount of raw material or spare parts via the wholesaler to the service center. Using fixed amounts will motivate the service center to minimize use.

Preferably, the data communication network is an extranet. Extranet systems are accessible only by authorized users, e.g., after input of a password or an identification code. Other suitable alternative data communication networks are intranet systems, the Internet, e.g. a fenced-in part of the Internet allowing only limited access to authorized users, or any other suitable network of data processing systems, via public cable systems, such as the telephone network, private cable systems and/or wireless data transmission systems and protocols.

The user interfaces may be based on web technology, e.g., in the form of web sites defined in Hyper Text Markup Language (“HTML”) and may be readable by means of browser programs. Similar to the Internet, the TCP/IP protocol is a suitable protocol for an extranet.

The object of the invention is also achieved with a computer program, or any suitable data carrier storing it, for organizing service jobs for a fleet of vehicles, e.g., for maintenance, repair, restyling and/or refinishing, allowing a number of service center entries, at least one fleet manager's entry, and, optionally, one or more suppliers' entries to communicate with one or more data processing systems via a data communication network, the program comprising routines for providing a user interface to the fleet manager entry for sending a request for reading access to a status database relating to the service status of all vehicles present at one or more of the service centers, as well as routines for providing the service center's entry with a user interface for updating the status database.

Preferably, the program includes routines for providing a supplier's entry for reading information from a stock database including information about the stock of one or more products present at one or more of the service centers, and optionally allowing reading information from the status database.

Optionally, the program can give access to an on-line manual for repair or refinishing instructions, for example instructions on how to paint a specific type of car in a given house style, including the size, position, and colour of a logo, formulation of the background colour, application methods, etc.

The invention can for instance involve the use of a server system linked to a data communication network, comprising a memory storing a status database and a computer program for providing a first user interface for reading and editing the status database and for providing a second user interface to a remote client of an identified authorized user for reading the status database. Such a server can be any kind of suitable computer, e.g., a mainframe or a personal computer, run by an operating system allowing communication in a network, e.g. Windows®, Linux® or Unix®. The server may be physically located at a service center for example.

In a preferred embodiment, the server system comprises a memory storing a stock database and a computer program for providing a first user interface for reading and editing the stock database and for providing a second user interface to a remote client of an identified authorized user for reading the stock database.

The invention may also involve a server system for use by a supplier of products for vehicle servicing, the server system comprising a computer program comprising routines to access a status database and a stock database in a remote data processing system of a service center and a routine for calculating the need for additional stocks of products for planned service jobs.

### BRIEF DESCRIPTION OF THE DRAWINGS

The invention is further described and illustrated by the following drawings. In the drawings:

FIG. 1: shows a first user interface for a fleet manager entry;

FIG. 2: shows a second user interface for a fleet manager entry;

FIG. 3: shows a service center's entry;

FIG. 4: shows a supplier's entry user interface.

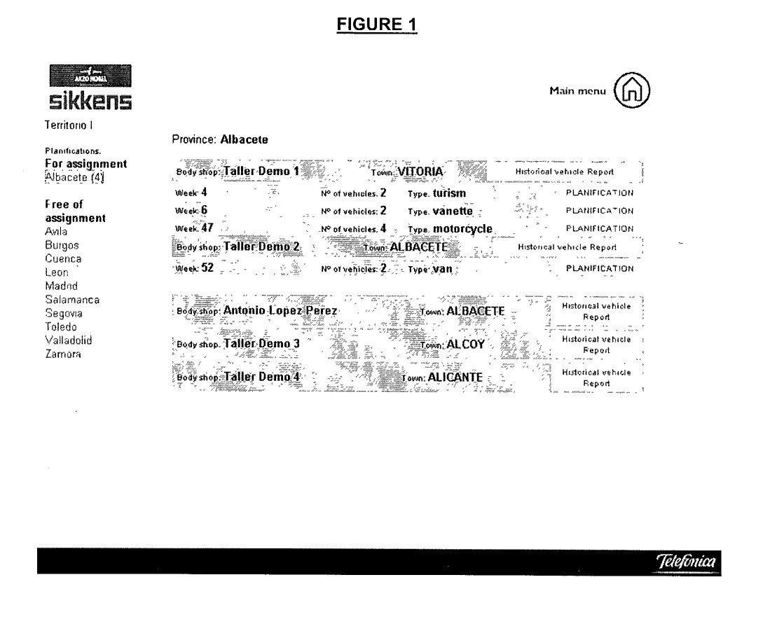

FIGS. 1-4 relate to an embodiment of the invention used for organizing and planning the repainting of a fleet of cars following a redesign of the fleet owner's house style. The fleet owner owns a large number of cars of different types, distributed over a large geographical area. The service centers are body shops for refinishing cars.

Whereas the computer program may present all users with the same starting page, allowing input of a password or identification code, upon recognizing the specific authorized user it will present him with a user-dependent user interface, as shown in the following figures.

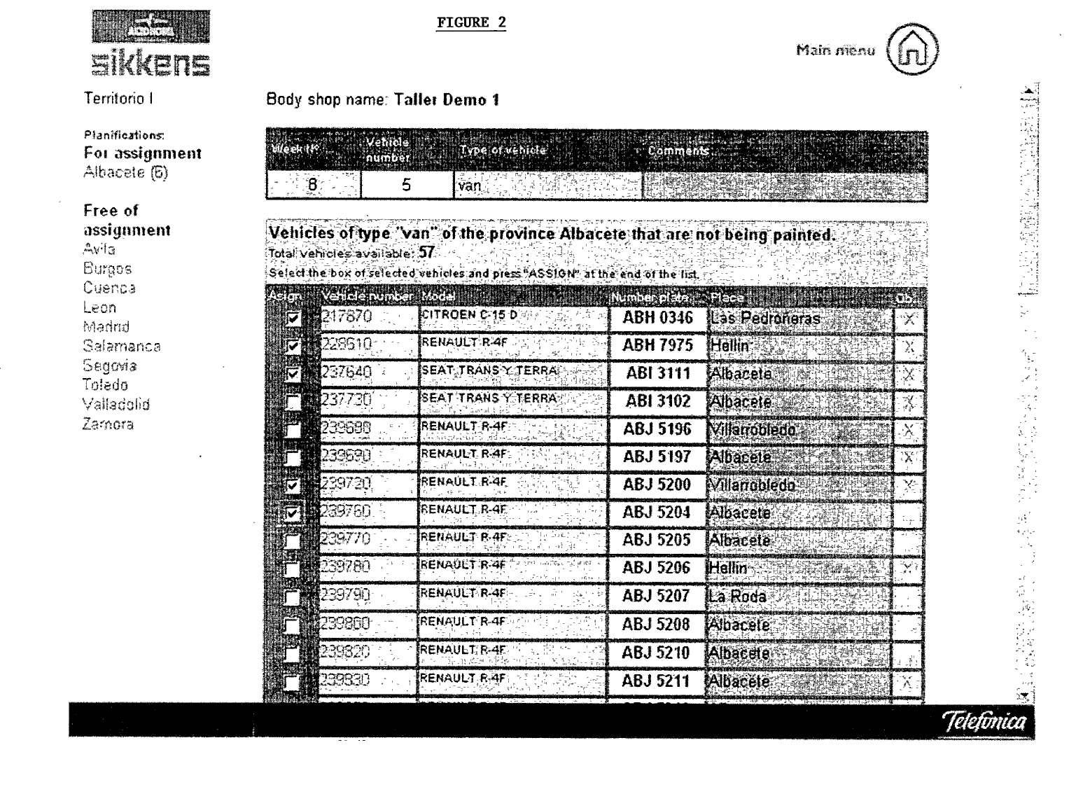

FIG. 1 shows a user interface as displayed on a computer display at a fleet owner's user terminal. The displayed information includes, on the left side, a first column with a list of locations where body shops have been selected for carrying out the refinishing jobs. The top part of the list lists locations having free capacity to carry out refinishing job. The bottom part is for locations to which are not available for assignment of refinishing jobs in the time period in question. In this example, refinishing jobs can be assigned only to the location of Albacete, where there are five body shops. Clicking on Albacete in this first column results in displaying a second column, to the right of the first column. In this second column, the five body shops (Taller Demo 1 and 2, Antonio Lopez Perez, and Taller Demo 3 and 4 respectively) in Albacete are listed. Clicking on the name of the body shops pops down an overview of how many cars are scheduled to be refinished by the body shop in question and in which weeks. The types of cars are also indicated. Every body shop involved can indicate the types and numbers of cars it can take for every week it wants. Clicking on a week number result in a new window, shown in FIG. 2.

In FIG. 2, the left column is identical to the left column of FIG. 1. In the second part of this window, the top row shows the week number of the selected week, the number of vehicles that can be serviced in the selected week by the selected body shop and the type of vehicles. Under the top row, a list is shown of all van-type vehicles which are located in the selected region (Albacete) and which need to be refinished. All vehicles are identified by a vehicle number (left column), model and number plate. The subsequent column lists the places where the vehicles are located. In the Ob. (“observations”) column, it is indicated by a cross if there are any observations or remarks for the vehicle in question. The user can click on the tick boxes in the very first column, under the heading “assign” to assign the refinish job for a vehicle to the selected body shop.

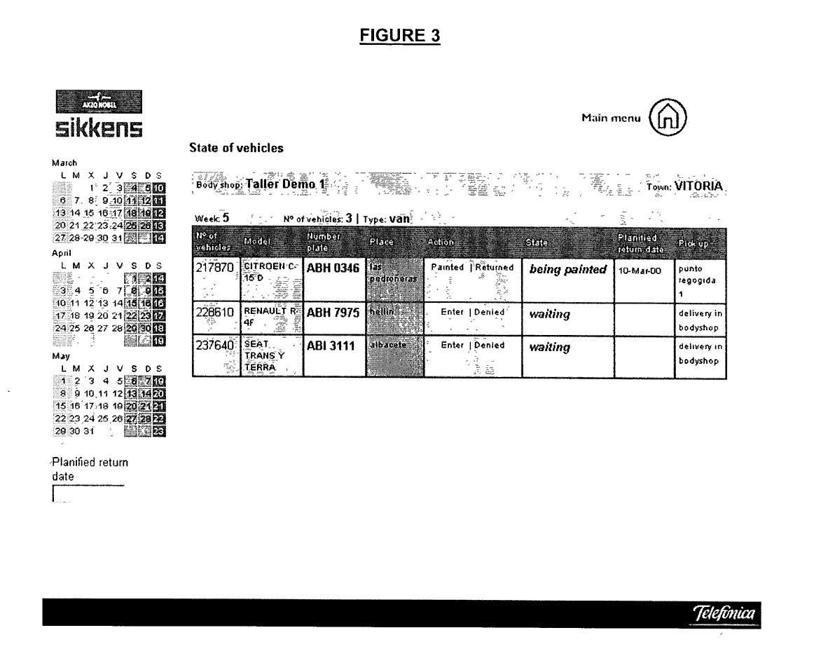

FIG. 3 shows the user entry for a body shop. The left side shows a calendar 15 spanning a period of three months, allowing selection by a mouse click of a planned return date, which after selection shows up in the selection window below the. calendar. Further to the right, the week 5 part of a status database of a selected body shop called “Taller Demo 1” located in the town of Vitoria is shown. Three van-type cars are scheduled to be refinished by this body shop in this week 5. From left to right, the first column gives the internal administrative identification numbers of the cars in question. The second column lists the models. The third column lists the corresponding numbers of licence plates. The fourth column lists the places where the cars come from. Actions to be done are listed in the fifth column. In this column, a body shop can click on “denied” if it refuses a car, for instance when the body shop is not able to meet the quality standards set by the fleet owner or by the paint supplier for the job in question. If the body shop accepts the job, it can click “enter”.

The present status is given in the following column, showing that the first car is presently being painted, whereas the other two are still waiting for acceptance. Planned return dates are listed in the seventh column. The final column on the right shows if the car is delivered to the body shop by the fleet owner, or if the body shop should pick it up somewhere.

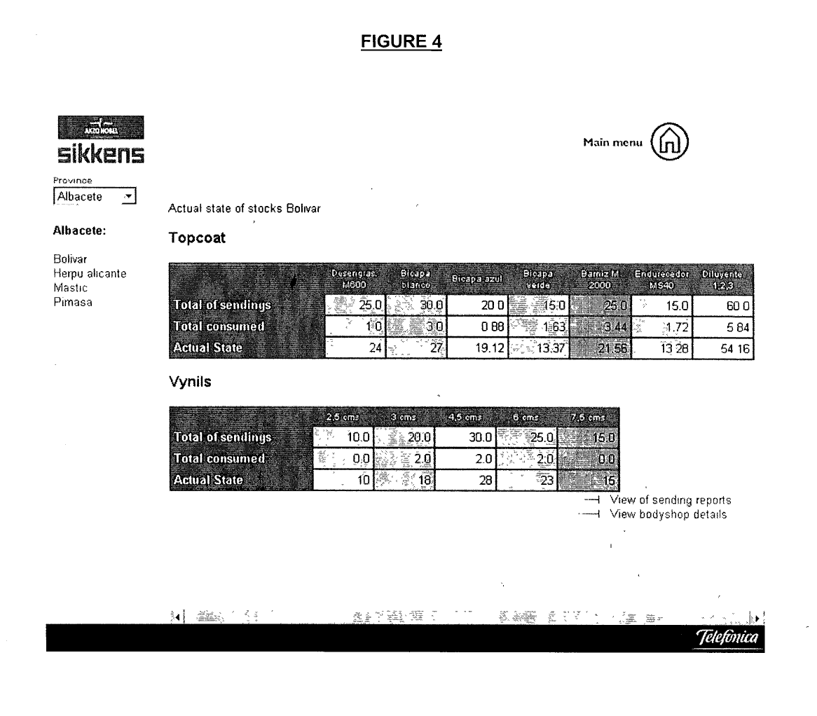

FIG. 4 shows a supplier's entry comprising a cascade of two windows. In the first window, underlying the second one, the supplier can select a region in the selection window at the top end of the column on the left side. In this case, Albacete is selected. The paint materials are distributed via wholesalers. In this example, wholesaler Bolivar is active in Albacete. Selecting Albacete gives an overview of the stock of Wholesaler Bolivar in the second column. The stock includes top coats and vinyls. The group of top coats includes degreaser, three different colours, a transparent lacquer, a hardener, and a thinner. The vinyls include self-adhesive plastic foils showing the required graphics, e.g., a logo, in different sizes. The second window, partly laying over the first one, shows the number of units sent to wholesaler Bolivar, as well as the number of consumed units, and the number of actually present stock. This way, it can be monitored when the body shop will need a fresh supply of materials. Moreover, it can also be monitored if the body shop uses materials for refinishing jobs for other customers than the fleet owner in question.

1) A method for servicing a fleet of vehicles, e.g., for maintenance, repairs, restyling and/or refinishing, using at least one data processing system and a number of user entries, including service center entries and at least one fleet manager's entry, at least a part of the user entries being linked to the data processing system via a data communication network, wherein
at least one of the data processing systems comprises a status database relating to the service status of all vehicles present at the service center;
the data processing system provides the fleet manager's entry with a user interface for requesting access to the status database for reading status information;
the data processing system provides the service center's entry with a user interface for updating the status database;
on the basis of information derived from the status database the fleet manager adjusts the planning of servicing jobs.

2) The fleet servicing method according to claim 1, wherein one or more of the data processing systems are linked to a third type of user entry for one or more suppliers, e.g. paint suppliers, and include a stock database including information about the stock of one or more products present at one or more of the service centers, and optionally allowing reading information from the status database.

3) The fleet management method according to claim 1, wherein the data communication net work is an extranet.

4) A computer program for organizing service jobs for a fleet of vehicles, e.g., for maintenance, repairs, restyling and/or refinishing, allowing a number of service center entries, at least one fleet manager's entry, and, optionally, one or more supplier's entries to communicate with one or more data processing systems via a data communication network, the program comprising routines for providing a user interface to the fleet manager entry for sending a request for reading access to a status database relating to the service status of all vehicles present at one or more of the service centers, as well as routines for providing the service center's entry with a user interface for updating the status database.

5) The computer program according to claim 4, wherein the program includes routines for providing a supplier's entry for reading information from a stock database including information about the stock of one or more products present at one or more of the service centers, and optionally allowing reading information from the status database.

6) A Data carrier storing a computer program according to claim 4.

7) A server system for use at a service center, linked to a data communication network, comprising a memory storing a status database and a computer program for providing a first user interface for reading and editing the status database and for providing a second user interface to a remote client of an identified authorized user for reading the status database.

8) The server system according to claim 7, comprising a memory storing a stock database and a computer program for providing a first user interface for reading and editing the stock database and for providing a second user interface to a remote client of an identified authorized user for reading the stock database.

9) A server system for use by a supplier of products for vehicle servicing, the server system comprising a computer program comprising routines to access a status database and a stock database in a remote data processing system of a service center and a routine for calculating the need of additional stock of products needed for planned service jobs.
